(19) United States
(12) Patent Application Publication
(10) Pub. No.: US 2026/0299340 A1
(43) Pub. Date: Oct. 1, 2026

(54) LAMINATED PANE WITH ELECTRICALLY SWITCHABLE MIRROR ELEMENT AND REDUCED LIGHT TRANSMITTANCE

(71) Applicant: SAINT-GOBAIN SEKURIT FRANCE, THOUROTTE (FR)

(72) Inventors: Sebastian ARENDT, HERZOGENRATH (DE); Yahya MOTEMANI SHARABIANI, HERZOGENRATH (DE); Siyamak MEMAR JAVID, HERZOGENRATH (DE); Valentin SCHULZ, HERZOGENRATH (DE)

(21) Appl. No.: 19/479,169

(22) PCT Filed: Apr. 28, 2024
(86) PCT No.: PCT/EP2024/061707

§ 371 Date: Oct. 27, 2025

(30) Foreign Application Priority Data
Apr. 28, 2023 (EP) 23170639.1

(51) Int. Cl. G02F 1/1333; E06B 9/24; G02F 1/1335

(52) U.S. Cl. CPC G02F 1/133308; E06B 9/24; G02F 1/133553; E06B 2009/2464

(57) ABSTRACT

A laminated pane for separating an interior from an external environment, includes an outer pane and an inner pane, which are firmly connected to each other by at least one thermoplastic interlayer, wherein the outer pane and the inner pane each have a surface facing the external environment and a surface facing the interior, wherein an electrically switchable mirror element is arranged between the outer pane and the inner pane, wherein the laminated pane is designed such that it has a light transmittance of more than 70% in a first region on the side of the mirror element facing the external environment and a light transmittance of a maximum of 70% in a second region on the side of the mirror element facing the interior.

The present invention lies in the technical field of pane manufacturing and relates to a laminated pane with an electrically switchable mirror element and reduced light transmittance. The invention further extends to the use of the laminated pane according to the invention.

The interior of a motor vehicle or a building can heat up strongly in summer at high ambient temperatures and under intense direct solar radiation. Against the background of a reduction of CO₂ emissions, it is desirable to reduce heating by direct solar radiation in a vehicle or building since this can save energy for cooling the interior. In electric vehicles, the savings can also increase the range. Infrared radiation and radiation in the visible wavelength range (light) are primarily responsible for heating the interior.

In order to counteract this problem, it is known to use panes with emissivity-reducing coatings, which are also referred to as low-E coatings and have reflective properties with respect to thermal radiation. At high outside temperatures, the emissivity-reducing coating prevents the thermal radiation emanating from the heated pane from entering the interior. In addition, a portion of infrared solar radiation is reflected. At low outside temperatures, the coating reduces the heat transfer from the heated interior via the pane into the external environment. Overall, such a pane with reduced emissivity improves thermal comfort. Panes with emissivity-reducing coatings are used in the vehicle sector, in particular as roof panes. Suitable emissivity-reducing coatings for this purpose are known, for example, from EP2141135A1, WO2011/105991 A1, WO2013/131667 A1, and WO2018/206236 A1.

Silver-based layers are also used to reflect IR radiation, in particular in the near-infrared range. For example, in laminated panes, silver-based layers are applied to the interior-side surface (side II) of the outer pane in combination with emissivity-reducing layers applied to the interior-side surface (side IV) of the inner pane.

These measures allow IR radiation incident on the laminated pane to be reflected and blocked, which reduces the energy input into the interior.

In addition to IR radiation, radiation in the visible wavelength range (i.e., light) also has a considerable influence on the energy input into the interior. This often cannot be avoided, since a minimum transparency of the pane to light may be desired or required by law. As is known in the art, approximately 44% of the energy input into an interior can be caused by visible light. In order to reduce light transmittance, tinted thermoplastic interlayers and/or tinted panes are used. However, tinted interlayers and tinted panes can heat up considerably due to solar radiation and thus increase the energy input into an interior through the emitted thermal radiation. As practice has shown, tinted elements can sometimes become so hot that contact with a body part can cause burns. In order to improve the light-reflective properties of laminated panes, it would also be possible to use electrically switchable, light-reflective functional films.

Emissivity-reducing layers generally have the disadvantage that they provide the pane with a certain interior-side light reflection, in particular at shallow reflection angles. This can have disturbing effects. For example, the display of the navigation system or other electronic displays can be reflected at the roof pane, which can be disturbing to people on the back seat. The same naturally applies to light-reflective functional films.

DE 1596815A1 , JP 2006106343A, and JP 2006267670 A each disclose a laminated pane with an electrically switchable mirror element.

In contrast, the object of the present invention is to avoid the aforementioned disadvantages and to provide an improved laminated pane, through which the energy input into the interior is reduced and, in addition, less light reflection occurs on the interior side. In addition, the laminated pane should be able to be provided by a cost-effective, industrially applicable process, wherein the laminated pane should be of high quality and long-term stability.

According to the proposal of the invention, these and further objects are achieved by a laminated pane with the features of the independent claim. Preferred embodiments result from the dependent claims.

The invention presents a laminated pane, which is provided to be installed in an opening of a vehicle or building and serves to separate an interior from an external environment.

The laminated pane comprises an outer pane with a surface (side I) facing the external environment and a surface (side II) facing the interior, as well as an inner pane with a surface (side III) facing the external environment and a surface (side VI) facing the interior. The outer pane and the inner pane are firmly connected to each other by at least one thermoplastic interlayer. Furthermore, the laminated pane has an electrically switchable mirror element with light-reflective properties between the outer pane and the inner pane, which mirror element can reflect light incident on the laminated pane from the external environment, i.e., radiation in the visible wavelength range. The mirror element can typically also reflect light incident on the laminated pane from the interior, wherein, according to the invention, the incidence of light from the external environment is the crucial factor in reducing the energy input into the interior. The mirror element is suitable and intended to reflect light incident on the mirror element from the external environment. In other words, the mirror element serves to reflect light that is incident on the mirror element from the external environment. The subject matter of the invention therefore relates to a laminated pane with an electrically switchable mirror element for reflecting light incident from the external environment.

The laminated pane can be divided by the electrically switchable mirror element into a first region that contains the outer pane and is located on the side of the mirror element facing the external environment and into a second region that contains the inner pane and is located on the side of the mirror element facing the interior. The naming of the two regions of the laminated pane as “first region” and “second region” is merely used for easier differentiation. The first region may also be referred to as the outer region and the second region as the inner region of the laminated pane. The first region comprises all components of the laminated pane on the side of the mirror element facing the external environment, with the exception of an opaque masking layer (black print). In a corresponding manner, the second region comprises all components of the laminated pane on the side of the mirror element facing the interior. The laminated pane according to the invention is generally designed such that it has a light transmittance of more than 70% in the first region and a light transmittance of a maximum of 70% in the second region. For the light transmittance, all components of the laminated pane in the first region and second region must be taken into account, i.e., the light transmittance in the first region is the total light transmittance of all components of the laminated pane in the first region and the light transmittance in the second region is the total light transmittance of all components of the laminated pane in the second region. Accordingly, the laminated pane has different light transmittances on the two sides of the electrically switchable mirror element, wherein the light transmittance is lower in the second region of the laminated pane on the side of the mirror element facing the interior than in the first region of the laminated pane on the side of the mirror element facing the external environment.

Means for reducing the light transmittance in a laminated pane are known per se to a person skilled in the art.

In one embodiment, the laminated pane has a tinted (colored) thermoplastic interlayer and/or a tinted (colored) inner pane and/or a (dark) transmission-reducing coating, which is produced by deposition, in the second region in order to reduce the light transmittance. The transmission-reducing coating is preferably deposited on the inner pane.

In one embodiment, the laminated pane has a non-tinted outer pane and/or a non-tinted thermoplastic interlayer in the first region. Advantageously, the outer pane and/or a thermoplastic interlayer in the first region is clear, i.e., non-tinted or uncolored. In an alternative embodiment, the laminated pane has a tinted outer pane and/or a tinted thermoplastic interlayer in the first region. The tinted outer pane and/or the tinted thermoplastic interlayer in the first region may, for example, have a lower tint than the inner pane and/or the thermoplastic interlayer in the second region.

The invention advantageously allows the energy input into the interior in the visible wavelength range to be reduced by the electrically switchable mirror element. In addition, the reduced light transmittance in the second region of the laminated pane on the side of the mirror element facing the interior can prevent unwanted light reflections on the interior side. These are great advantages of the laminated pane according to the invention.

In one embodiment of the invention, the laminated pane is designed such that it has a light transmittance of more than 80% in the first region and at the same time a light transmittance of a maximum of 50%, preferably a maximum of 30%, and in particular preferably a maximum of 10%, in the second region. On the one hand, this measure allows for particularly effective light reflection of light incident from outside; on the other hand, the greatly reduced light transmittance in the second region allows light reflections on the interior side to be prevented particularly effectively.

In one embodiment of the invention, the laminated pane is designed such that it has a total light transmittance (TL) of a maximum of 65%, preferably a maximum of 50%, particularly preferably a maximum of 30%, and most particularly preferably a maximum of 15%. For example, a dark roof pane with TL=7%+IR-reflective (Ag) layer+Low-E layer on side IV has a TTS of approximately 12-13% (without reflection in the visible range). TTS (Total Transferred Solar Energy) is the term used to describe the heat input by radiation at visible and non-visible wavelengths.

The electrically switchable mirror element is flat and extends over a substantial portion of the surface area of the laminated pane, for example at least 35%, at least 40%, at least 60%, at least 70%, at least 80%, or at least 90% of the surface area of the laminated pane.

The electrically switchable mirror element is designed such that it can be switched into a non-reflective state (with respect to light) or a reflective state (with respect to light) by applying a corresponding operating voltage. Advantageously, the electrically switchable mirror element is designed such that at least 35%, at least 40%, at least 50%, at least 60%, at least 70%, at least 80%, or at least 90% of the incident (visible) light is reflected. For the purposes of the present invention, a “reflective state” is also understood to mean a semi-reflective state, in which only a portion of the incident visible light is reflected.

Electrically switchable mirror elements are known per se to a person skilled in the art. In one embodiment of the invention, the electrically switchable mirror element is a prefabricated electrically switchable functional element (no coating), which is designed such that it can be electrically switched into a non-reflective state (with respect to light) or a reflective state (with respect to light) by applying a corresponding operating voltage. Such electrically switchable functional elements are typically in film form and can be easily laminated into a laminated pane. The electrically switchable functional element or functional film may, for example, be arranged in a thermoplastic film, which surrounds the functional element in the shape of a frame in the manner of a passepartout in order to avoid local height differences in the laminate and unwanted forces acting on the electrically switchable functional element. Prefabricated, electrically switchable liquid-crystal-based functional elements in film form are commercially available (e.g., from Kent Optronics).

In one embodiment of the invention, the electrically switchable functional element in film form is arranged between a thermoplastic interlayer in the first region and a thermoplastic interlayer in the second region, wherein the thermoplastic interlayer in the second region has a tint. Advantageously, the thermoplastic interlayer in the first region has no tint or at least a lower tint than the thermoplastic interlayer in the second region. The electrically switchable functional element is therefore embedded between two thermoplastic interlayers of different tints, wherein the electrically switchable functional element can additionally be arranged in a frame-shaped surrounding thermoplastic interlayer. This measure has the advantage that the thermoplastic interlayer used to laminate the electrically switchable functional element in the second region is simultaneously used to reduce the light transmittance in the second region. Additionally, the inner pane may have a tint, while the outer pane is clear or at least has a lower tint than the inner pane.

In one embodiment of the invention, the electrically switchable mirror element is in the form of an electrically switchable functional coating, which is designed such that it can be switched into a non-reflective state (with respect to light) or a reflective state (with respect to light) by applying a corresponding operating voltage. Such electrically switchable functional coatings are known in the art (see, for example, AIST, Japan) and are, for example, based on a Mg—Ni alloy as an electrically switchable mirror layer.

Preferably, the electrically switchable functional coating is applied to the inner pane by deposition, preferably to the surface (side III) of the inner pane facing the exterior. Preferably, a (dark) transmission-reducing coating is applied to the interior side of the electrically switchable functional coating. Preferably, the electrically switchable functional coating is arranged on the transmission-reducing coating. Preferably, the transmission-reducing coating is deposited on the surface (side III) of the inner pane facing the exterior and the electrically switchable functional coating is deposited on the transmission-reducing coating.

The transmission-reducing coating is, for example, based on titanium nitride and/or titanium carbide or is an amorphous carbon layer.

The transmission-reducing coating is typically applied over the entire surface area of the surface of the inner pane, possibly with the exception of a peripheral edge region and/or other locally limited regions, which may, for example, be used for transmitting data. The coated portion of the surface of the inner pane is preferably at least 90%. In one embodiment, an emissivity-reducing coating is applied to the inner pane, preferably to the surface (side IV) of the inner pane facing the interior. This can advantageously reduce the energy input into the interior by IR radiation. The emissivity-reducing coating may also be referred to as a heat-reflective coating or low-E coating. Emissivity is the measure that indicates how much thermal radiation the pane emits into an interior in the installation position in comparison to an ideal heat emitter (i.e., a black body). The emissivity-reducing coating has the function of preventing heat from entering the interior (IR components of solar radiation and, in particular, thermal radiation from the laminated pane itself) and also from radiating out of the interior. It has reflective properties with respect to infrared radiation, in particular with respect to thermal radiation in the spectral range of 5-50 μm (cf. standard DIN EN 12898:2019-06).

Advantageously, the emissivity-reducing coating contains at least one layer of a transparent conductive oxide (TCO), for example based on indium tin oxide (ITO), indium-zinc mixed oxide (IZO), aluminum-doped zinc oxide (AZO), gallium-doped zinc oxide (GZO), fluorine-doped tin oxide (FTO, SnO₂:F), or antimony-doped tin oxide (ATO, SnO₂:Sb).

The emissivity-reducing coating is typically applied over the entire surface area of the surface of the inner pane, possibly with the exception of a peripheral edge region and/or other locally limited regions, which may, for example, be used for transmitting data. The coated portion of the surface of the inner pane is preferably at least 90%. Additionally or alternatively, an IR-reflective coating is preferably applied to the surface of the outer pane facing the interior, whereby the energy input into the interior can be (further) reduced.

In the laminated pane according to the invention, the light transmittance in the second region of the laminated pane is lower than in the first region of the laminated pane. “Light” is understood to mean the visible spectral range of 380 nm to 780 nm.

The total light transmittance (TL) of the laminated pane and the reflected portion of light are measured in accordance with DIN ISO 5033 (old standard) or DIN EN ISO/CIE 11664 (new standard). The transmitted portion of light is determined in transmission, and the reflected portion of light is determined in reflection. A standard light source (e.g., light source A, D65) is used under conditions specified in the standard, wherein the quotient of the intensity of the transmitted light to the intensity of the incident light is ascertained in order to determine the percentage value of the transmittance. In this case, the light source is arranged on one side of the laminated pane, and a light sensor is arranged on the other side of the laminated pane. In order to determine the percentage value of the reflectance, the quotient of the intensity of the reflected light to the intensity of the incident light is ascertained. In this case, the light source and the light sensor are arranged on the same side of the laminated pane. The light transmittance of the first region or of the second region of the laminated pane is determined analogously, wherein, instead of the laminated pane, the first region or the second region of the laminated pane is examined separately.

The first pane and the second pane of the laminated pane may in principle have any chemical composition known to a person skilled in the art. The two panes preferably contain or consist of glass, particularly preferably flat glass, float glass, quartz glass, borosilicate glass, soda lime glass, or aluminosilicate glass. It is also conceivable that the two panes contain or consist of a clear plastic, preferably a rigid clear plastic, in particular polyethylene, polypropylene, polycarbonate, polymethyl methacrylate, polystyrene, polyamide, polyester, polyvinyl chloride, and/or mixtures thereof.

In one embodiment of the invention, the laminated pane contains or consists of glass. The thickness of each individual pane of the laminated pane can vary widely and thus be adapted to the requirements of the individual case. Preferably, panes with standard thicknesses of 0.5 mm to 25 mm and preferably of 0.5 mm to 5 mm are used. The size of the panes can vary widely and depends on its use. The laminated pane can have any three-dimensional shape and be planar or curved in one or more directions in space.

The two panes of the laminated pane are firmly connected to each other by at least one thermoplastic interlayer, which is created by laminating the two panes with one or more adhesive films. Each adhesive film preferably contains or consists of polyvinyl butyral (PVB), ethylene vinyl acetate (EVA), thermoplastic polyurethane (TPU), polyethylene terephthalate (PET), or mixtures or copolymers or derivatives thereof, particularly preferably PVB. The thickness of an adhesive film is preferably from 0.2 mm to 1 mm, for example 0.38 mm or 0.76 mm.

Methods known per se for laminating laminated panes can be used for laminating the laminated pane. Vacuum lamination in particular is well known and common, in which lamination takes place in a heatable and evacuatable chamber within, for example, about 60 minutes at a reduced pressure of, for example, 0.01 mbar to 800 mbar and temperatures of, for example, 80° C. to 170° C. Vacuum bag methods or vacuum ring methods known per se operate, for example, at approximately 200 mbar and, for example, 130° C. to 145° C. In roll lamination, pressing takes place in a calender between at least one pair of rollers or between a roller and a rigid support. The temperature during the pressing process is, for example, from 40° C. to 150° C. This is known in the art and therefore it does not need to be discussed in detail here.

The invention also extends to the use of the laminated pane according to the invention in buildings or in means of transportation for traffic on land, in the air, or on water, in particular in motor vehicles, for example as a roof pane, rear pane, and/or side pane. The various embodiments of the invention can be realized individually or in any combinations. In particular, the features mentioned above and explained below can be used not only in the specified combinations but also in other combinations or alone without departing from the scope of the present invention.

The invention is explained in more detail below with reference to exemplary embodiments, wherein reference is made to the accompanying figures. In a simplified, not-to-scale representation:

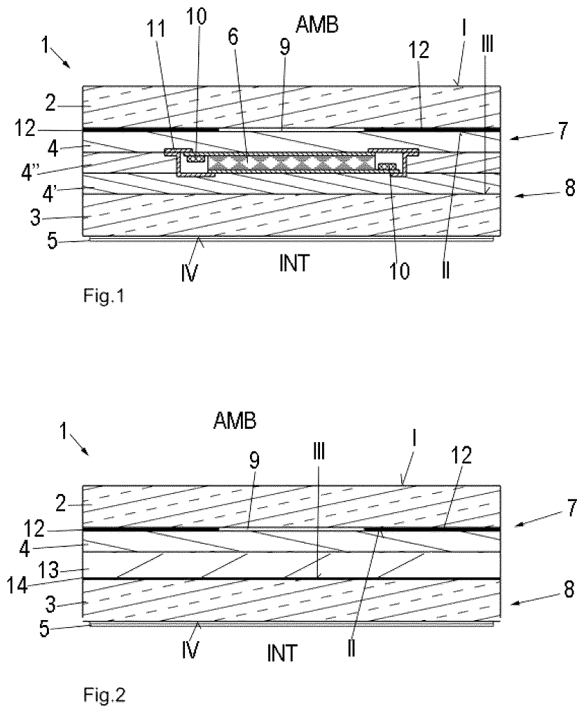

FIG. 1 is a schematic cross-sectional view of a first exemplary embodiment of the laminated pane according to the invention,

FIG. 2 is a schematic cross-sectional view of a second exemplary embodiment of the laminated pane according to the invention.

Two different exemplary embodiments of the laminated pane according to the invention, which is denoted as a whole by reference number 1, are explained with reference to FIGS. 1 and 2.

FIG. 1 is considered first. FIG. 1 illustrates, by means of a schematic cross-sectional view, a first exemplary embodiment of the laminated pane 1, which is provided to be inserted into an opening of a motor vehicle or building, where it separates an interior INT from the external environment AMB. The laminated pane 1 is, for example, the roof pane of a motor vehicle.

The laminated pane 1 comprises an outer pane 2 and an inner pane 3, which are firmly connected to each other via three thermoplastic interlayers 4, 4′, 4″. The outer pane 2 has a surface I facing the external environment and a surface II facing the interior. Likewise, the inner pane 3 has a surface III facing the exterior and a surface IV facing the interior. The outer surface I of the outer pane 2 and the interior-side surface IV of the inner pane are the exposed surfaces of the laminated pane, wherein, in the installation position, the surface I faces the external environment and the surface IV faces the interior of the vehicle or building. The outer pane 2 and the inner pane 3 are, for example, panes made of soda lime glass, with a thickness of 2.1 mm each. Preferably, the outer pane 2 is not tinted. However, situations may also arise in which a tinted outer pane 2 is advantageous, namely when the outer reflection of light is not visually appealing. Although this is disadvantageous with regard to the heat input (TTS), it is a good compromise between reflectivity and heat input. The interlayers 4, 4′, 4″ are, for example, formed by films made of polyvinyl butyral (PVB).

An emissivity-reducing coating 5 (low-E coating) is applied to the exposed, interior-side surface IV of the inner pane 3. The emissivity-reducing coating 5 improves the thermal comfort in the interior in that, at high outside temperatures, thermal radiation of the pane and portions of the solar radiation are reflected and, at low outside temperatures, the cooling of the interior is reduced. The emissivity-reducing coating 5 is based on ITO, for example.

Between the outer pane 2 and the inner pane 3, the laminated pane 1 contains an electrically switchable mirror element in the form of an electrically switchable, liquid-crystal-based functional film 6, which can be switched into a non-reflective state with respect to light or into a reflective state with respect to light by applying a suitable operating voltage. By means of the electrically switchable functional film 6, the laminated pane can be divided, at least notionally, into a first region 7 and a second region 8, wherein the first region 7 is located on the side of the electrically switchable functional film 6 facing the external environment and the second region 8 is located on the side of the electrically switchable functional film 6 facing the interior.

The electrically switchable functional film 6 is embedded between the two thermoplastic interlayers 4, 4′, wherein the electrically switchable functional film 6 is additionally surrounded by a thermoplastic interlayer 4″ in the manner of a passepartout. For this purpose, the electrically switchable functional film 6 is inserted into an opening or through-hole in the surrounding interlayer 4″ (interlayer film). It is understood that the thermoplastic interlayers 4, 4′, 4″ fuse during lamination. They are usually provided in film form before lamination. The electrically switchable functional film 6 has two terminal electrodes (busbars) 10, through which an operating voltage for switching the functional film can be applied.

The thermoplastic interlayer 4 is located in the first region 7; the thermoplastic interlayer 4′ is located in the second region 8.

Between the electrically switchable functional film 6 and the material of the thermoplastic interlayers 4, 4′, 4″, there is sealing material 11, which prevents diffusion processes.

Furthermore, on the interior-side surface II of the outer pane 2, the laminated pane 1 comprises an IR-reflective coating 9, which is, for example, based on silver. Decoated or coating-free regions are possible in order to allow the passage of radio signals.

The laminated pane 1 has a light transmittance of a maximum of 70% in the second region 8 and a light transmittance of more than 70% in the first region 7, i.e., the light transmittance in the second region 8 is lower than the light transmittance in the first region 7. This is achieved by a correspondingly high tint of the thermoplastic interlayer 4′ in the second region 8. By contrast, the thermoplastic interlayer 4 in the first region 7 is not tinted (clear) or has at least a lower tint than the thermoplastic interlayer 4′ in the second region 8. Additionally or alternatively, it would also be possible for the inner pane 3 to have a corresponding tint. The outer pane 2 is clear and has no tint.

The laminated pane 1 is furthermore provided with a black print 12 on the interior-side surface II of the outer pane 2, which black print covers the subjacent connections, sealing material and the like.

FIG. 2 illustrates a second exemplary embodiment of the laminated pane 1 according to the invention by means of a schematic cross-sectional view. In order to avoid unnecessary repetition, only the differences from the first exemplary embodiment explained in connection with FIG. 1 are described, and reference is made to the above explanations otherwise.

Accordingly, instead of the electrically switchable functional film 6, an electrically switchable functional coating 13 of the inner pane 3 is provided. The electrically switchable functional coating 13 is deposited on the surface III of the inner pane 3 facing the external environment, for example by sputtering. A transmission-reducing coating 14, which is, for example, based on titanium nitride and/or titanium carbide or is an amorphous carbon layer, is located between the electrically switchable functional coating 13 and the inner pane 3. During production, the transmission-reducing coating 14 is first deposited on the surface III of the inner pane 3 facing the external environment, for example by sputtering, followed by deposition of the electrically switchable functional coating 13 on the transmission-reducing coating 14, for example by sputtering. Analogously to the electrically switchable functional film 6, the electrically switchable functional coating 13 can be switched into a non-reflective state with respect to light or into a reflective state with respect to light by applying a suitable operating voltage.

In the exemplary embodiment of FIG. 2, the outer pane 2 and the inner pane 3 are connected to each other only by a clear (non-tinted) interlayer 4.

The laminated pane 1 has a light transmittance of a maximum of 70% in the second region 8 and a light transmittance of more than 70% in the first region 7, i.e., the light transmittance in the second region 8 is lower than the light transmittance in the first region 7. This is achieved by the transmission-reducing coating 14. Alternatively or additionally, the inner pane 3 may have a corresponding tint.

The laminated pane 1 of the exemplary embodiments of FIGS. 1 and 2 may optionally be brought into a state with light-reflective properties, wherein the first region 7 has a lower tint than the second region 8 so that a relatively large portion of the incident sunlight is reflected. Unwanted reflections on the interior side can be avoided by the strong transmittance reduction in the second region 8. The total heat input by radiation in the visible and non-visible wavelength range (TTS) of the laminated pane 1 is approximately 6%, which corresponds to a reduction of approximately 50% in comparison to conventional roof panes.

The electrically switchable functional film 6 and the electrically switchable functional coating 13 can be formed in segments.

The above statements show that the invention provides a novel laminated pane, which reduces the energy input into the interior of a motor vehicle or building through strong reflection of visible light and, in addition, avoids disadvantageous effects with regard to reflections on the interior side. The laminated pane can be easily produced using standard processes in the industrial series production of laminated panes. The laminated pane can be produced easily, cost-effectively, and with high quality.

### LIST OF REFERENCE SIGNS

1 Laminated pane
2 Outer pane
3 Inner pane
4, 4′, 4″ Interlayer
5 Emissivity-reducing coating
6 Functional film
7 First region
8 Second region
9 IR-reflective coating
10 Terminal electrode
11 Sealing material
12 Black print
13 Functional coating
14 Transmission-reducing coating
INT Interior
AMB External environment

1. A laminated pane for separating an interior from an external environment, comprising an outer pane, and an inner pane which are firmly connected to each other by at least one thermoplastic interlayer, wherein the outer pane and the inner pane each have a surface facing the external environment and a surface facing the interior, wherein an electrically switchable mirror element is arranged between the outer pane and the inner pane, wherein the laminated pane is designed such that the laminated pane has a light transmittance of more than 70% in a first region on a side of the mirror element facing the external environment and a light transmittance of a maximum of 70% in a second region on a side of the mirror element facing the interior.

2. The laminated pane according to claim 1, wherein the laminated pane is designed such that the laminated pane has a light transmittance of more than 80% in the first region and a light transmittance of a maximum of 50%, in the second region.

3. The laminated pane according to claim 1, which has a tinted inner pane, a tinted thermoplastic interlayer, and/or a transmission-reducing coating in the second region.

4. The laminated pane according to claim 1, which has
i) a non-tinted outer pane and/or a non-tinted thermoplastic interlayer in the first region, or
ii) a tinted outer pane and/or a tinted thermoplastic interlayer in the first region.

5. The laminated pane according to claim 1, which has a total light transmittance of a maximum of 65%,

6. The laminated pane according to claim 1, wherein the electrically switchable mirror element reflects at least 35% of the incident light.

7. The laminated pane according to claim 1, wherein the electrically switchable mirror element is an electrically switchable functional film, which is switchable into a non-reflective state with respect to light or into a reflective state with respect to light.

8. The laminated pane according to claim 7, wherein the electrically switchable functional film is arranged between a thermoplastic interlayer in the first region and a thermoplastic interlayer in the second region, wherein the thermoplastic interlayer in the second region has a tint.

9. The laminated pane according to claim 8, wherein the thermoplastic interlayer in the first region has no tint or a lower tint than the thermoplastic interlayer in the second region.

10. The laminated pane according to claim 1, wherein the electrically switchable mirror element is an electrically switchable functional coating, which is switchable into a non-reflective state with respect to light or into a reflective state with respect to light.

11. The laminated pane according to claim 10, wherein a transmission-reducing coating is applied to the interior side of the electrically switchable functional coating.

12. The laminated pane according to claim 11, wherein the electrically switchable functional coating is arranged on the transmission-reducing coating.

13. The laminated pane according to claim 11, wherein the transmission-reducing coating is based on titanium nitride and/or titanium carbide or is an amorphous carbon layer.

14. The laminated pane according to claim 1, wherein an emissivity-reducing coating is applied to the surface of the inner pane facing the interior and/or an IR-reflective coating is applied to the surface of the outer pane facing the interior.

15. A method comprising providing the laminated pane according to claim 1 in a building or in a vehicle of transportation for traffic on land, in the air, or on water.

16. The laminated pane according to claim 2, wherein the laminated pane has a light transmittance of a maximum of 30% in the second region.

17. The laminated pane according to claim 16, wherein the laminated pane has a light transmittance of a maximum of 10% in the second region.

18. The laminated pane according to claim 5, wherein the laminated pane has a total light transmittance of a maximum of 30%.

19. The laminated pane according to claim 18, wherein the laminated pane has a total light transmittance of a maximum of 15%.

20. The laminated pane according to claim 6, wherein the electrically switchable mirror element reflects at least 60% of the incident light.
